(19) United States
(12) Patent Application Publication
(10) Pub. No.: US 2026/0212789 A1
(43) Pub. Date: Jul. 23, 2026

(54) CONTROL METHOD AND APPARATUS, HEAD-MOUNTED DISPLAY DEVICE, AND MEDIUM

(71) Applicant: GOERTEK INC., Weifang, Shandong (CN)

(72) Inventors: Yufeng LI, Weifang, Shandong (CN); Mingming YANG, Weifang, Shandong (CN)

(21) Appl. No.: 19/143,032

(22) PCT Filed: Jun. 18, 2024
(86) PCT No.: PCT/CN2024/099795

§ 371 Date: Jun. 25, 2025

(30) Foreign Application Priority Data
Aug. 1, 2023 (CN) 202310960183.0

(51) Int. Cl. G09G 3/00; G02B 27/01; G06F 3/04815; G06F 3/0488; G06T 15/04

(52) U.S. Cl. CPC G09G 3/002; G02B 27/0172; G06F 3/04815; G06F 3/0488; G06T 15/04; G02B 2027/014

(57) ABSTRACT

Disclosed are a control method and apparatus, a head-mounted display device, and a medium. The method includes: in the operation process of a desktop environment, receiving a switching instruction of switching from a first Activity of a first application to a second Activity of the first application, wherein a first virtual screen running the first Activity and a first canvas rendering texture information of the first virtual screen are created in the desktop environment; in response to the switching instruction, acquiring identifier information of the second Activity; and when the identifier information of the second Activity indicates that a virtual screen needs to be created for the second Activity, creating a second virtual screen and a second canvas in the desktop environment, running the second Activity on the second virtual screen, and rendering texture information of the second virtual screen to the second canvas.

The present application claims the priority to the Chinese Patent Application No. 202310960183.0, entitled “CONTROL METHOD AND APPARATUS, HEAD-MOUNTED DISPLAY DEVICE, AND MEDIUM” filed with China Patent Office on Aug. 1, 2023, the entire contents of which are incorporated into the present application by reference.

### TECHNICAL FIELD

The present application relates to a technical field of wearable devices, and more particularly, to a control method, a control apparatus, a head-mounted display device, and a computer-readable storage medium.

### DESCRIPTION OF RELATED ART

With the continuous development of augmented reality (AR) technology, many AR products and AR applications have emerged. Taking the AR product being AR glasses as an example, a virtual screen may be added to the AR glasses, and a corresponding AR application runs on the virtual screen.

In the related art, when the AR application is a traditional Android application, the AR application usually has a plurality of Activities to run different functions in the AR application, and when a user needs to use different Activities, the different Activities need to be repeatedly switched, which makes the operation cumbersome.

### SUMMARY

Embodiments of the present disclosure provide a control method and apparatus, a head-mounted display device and a medium.

According to a first aspect of the embodiments of the present disclosure, a control method is provided, the control method including:
receiving a switching instruction for switching from a first Activity of a first application to a second Activity of the first application in a running process of a desktop environment, wherein a first virtual screen and a first canvas are created in the desktop environment, the first virtual screen runs the first Activity, and the first canvas renders texture information of the first virtual screen;
obtaining identification information of the second Activity in response to the switching instruction; and
when the identification information of the second Activity indicates that a virtual screen needs to be created for the second Activity, creating a second virtual screen and a second canvas in the desktop environment, running the second Activity on the second virtual screen, and rendering texture information of the second virtual screen to the second canvas.

Optionally, the obtaining the identification information of the second Activity in response to the switching instruction includes:
obtaining a first mapping table and class name information of the second Activity in response to the switching instruction, wherein the first mapping table reflects a correspondence between class name information of an Activity of the first application and identification information of the Activity, and the identification information is used to indicate whether a virtual screen needs to be created for the Activity; and
obtaining the identification information of the second Activity according to the first mapping table and the class name information of the second Activity.

Optionally, the first Activity is an initial Activity, and before the receiving the switching instruction for switching from the first Activity of the first application to the second Activity of the first application, the method further includes:
receiving a start instruction for starting the first application in the running process of the desktop environment; and
in response to the start instruction, creating the first virtual screen and the first canvas in the desktop environment, running the first Activity on the first virtual screen, and rendering texture information of the first virtual screen to the first canvas.

Optionally, the method further includes:
creating a third virtual screen, a third canvas, a fourth virtual screen, and a fourth canvas in the desktop environment, wherein the third virtual screen runs a third Activity of a second application, the third canvas renders texture information of the third virtual screen, and the fourth virtual screen runs a fourth Activity of the second application;
displaying the first canvas and the second canvas in a stacked manner, and displaying the first canvas or the second canvas at a top layer as a first main canvas corresponding to the first application; and
displaying the third canvas and the fourth canvas in a stacked manner, and displaying the third canvas or the fourth canvas at a top layer as a second main canvas corresponding to the second application.

Optionally, the method further includes:
receiving a first touch input for a target main canvas, wherein the target main canvas is the first main canvas or the second main canvas;
expanding and displaying other canvases stacked with the target main canvas in response to the first touch input.

Optionally, the method further includes:
obtaining package name information of the first application, attribute information of the first virtual screen, attribute information of the second virtual screen, class name information of the first Activity, and class name information of the second Activity;
updating a second mapping table and a third mapping table based on the package name information of the first application, the attribute information of the first virtual screen, the attribute information of the second virtual screen, the class name information of the first Activity, and the class name information of the second Activity; and
obtaining package name information of the second application, attribute information of the third virtual screen, attribute information of the fourth virtual screen, class name information of the third Activity, and class name information of the fourth Activity;
updating the second mapping table and the third mapping table based on the package name information of the second application, the attribute information of the third virtual screen, the attribute information of the fourth virtual screen, the class name information of the third Activity, and the class name information of the fourth Activity; and
wherein the second mapping table reflects a correspondence between package name information of any application and attribute information of a virtual screen running the any application; and
the third mapping table reflects a correspondence between attribute information of any virtual screen and class name information of an Activity running on the any virtual screen.

Optionally, the method further includes:
obtaining class name information of a target Activity when a second touch input for the target Activity is received;
querying the third mapping table according to the class name information of the target Activity to obtain attribute information of a target virtual screen corresponding to the class name information of the target Activity; and
distributing, according to the attribute information of the target virtual screen, the second touch input to the target Activity running on the target virtual screen for response.

Optionally, the method further includes:
obtaining package name information of a target application in response to a first close instruction for closing the target application;
querying the second mapping table according to the package name information of the target application to obtain attribute information of a target virtual screen corresponding to the package name information of the target application;
querying the third mapping table according to the attribute information of the target virtual screen to obtain attribute information of a target Activity corresponding to the attribute information of the target virtual screen; and
releasing the corresponding target Activity according to the attribute information of the target Activity.

Optionally, the method further includes:
obtaining class name information of the target Activity in response to a second close instruction for closing the target Activity;
querying the third mapping table according to the class name information of the target Activity to obtain attribute information of a target virtual screen corresponding to the class name information of the target Activity; and
releasing the target Activity running on the target virtual screen according to the attribute information of the target virtual screen and the class name information of the target Activity.

According to a second aspect of the embodiments of the present disclosure, a control apparatus is provided, the control apparatus including:
a receiving module configured for receiving a switching instruction for switching from a first Activity of a first application to a second Activity of the first application in a running process of a desktop environment, wherein a first virtual screen and a first canvas are created in the desktop environment, the first virtual screen runs the first Activity, and the first canvas renders texture information of the first virtual screen;
an acquisition module configured for obtaining identification information of the second Activity in response to the switching instruction; and
a running module configured for creating a second virtual screen and a second canvas in the desktop environment when the identification information of the second Activity indicates that a virtual screen needs to be created for the second Activity, running the second Activity on the second virtual screen, and rendering texture information of the second virtual screen to the second canvas.

According to a third aspect of the embodiments of the present disclosure, a head-mounted display device is provided, the head-mounted display device including:
a memory configured to store executable computer instructions; and
a processor configured to perform, under control of the executable computer instructions, the control method according to the first aspect.

According to a fourth aspect of the embodiments of the present disclosure, a computer-readable storage medium, on which computer instructions are stored, is provided, wherein the computer instructions, when executed by a processor, implements the control method according to the first aspect.

A beneficial effect of the embodiments of the present disclosure is that: a first virtual screen and a first canvas are created in a desktop environment, the first virtual screen runs a first Activity of a first application, and the first canvas renders texture information of the first virtual screen, and if a switching instruction for switching from the first Activity to a second Activity of the first application is received, identification information of the second Activity may be obtained in response to the switching instruction, and in a case in which the identification information of the second Activity indicates that a virtual screen needs to be created for the second Activity, a second virtual screen and a second canvas are created in the desktop environment, and the second Activity runs on the second virtual screen, and texture information of the second virtual screen is rendered to the second canvas, so that different Activities of the first application can be simultaneously presented to a user, thereby implementing an effect of running multiple different Activities of the same application, and the user does not need to repeatedly switch between different Activities.

Other features and advantages of the present disclosure will become apparent from the following detailed description of exemplary embodiments of the present disclosure with reference to the accompanying drawings.

### BRIEF DESCRIPTION OF DRAWINGS

In order to more clearly illustrate the embodiments of the present application or the technical solutions in the prior art, the drawings required to be used for the content of the embodiments or the prior art will be briefly introduced in the following. Obviously, the drawings in the following description are merely some embodiments of the present application, and for those of ordinary skill in the art, other drawings can also be obtained from the provided drawings without any creative effort.

FIG. 1 is a schematic diagram of hardware configuration of a head-mounted display device according to an embodiment of the present disclosure;

FIG. 2 is a schematic flowchart of a control method according to an embodiment of the present disclosure;

FIG. 3 is a functional block diagram of a control apparatus according to an embodiment of the present disclosure;

FIG. 4 is a functional block diagram of a head-mounted display device according to an embodiment of the present disclosure.

Implementations, functional features, and advantages of the present disclosure will be further described with reference to the accompanying drawings and embodiments.

### DETAILED DESCRIPTIONS

The following clearly and completely describes the technical solutions in the embodiments of the present disclosure with reference to the accompanying drawings in the embodiments of the present disclosure, and obviously, the described embodiments are only a part of the embodiments of the present disclosure, but not all the embodiments. Based on the embodiments of the present disclosure, all other embodiments obtained by those skilled in the art without creative efforts fall within the protection scope of the present disclosure.

It should be noted that all directional indications (such as up, down, left, right, front, and rear) in the embodiments of the present disclosure are merely used to explain a relative position relationship and a movement condition and the like between components in a specific posture (as shown in the accompanying drawings), and if the specific posture changes, the directional indication changes accordingly.

In addition, in the embodiments of the present disclosure, descriptions such as “first”, “second” and the like are merely used for description purposes, and cannot be understood as indicating or implying relative importance thereof or implicitly indicating a quantity of indicated technical features. Thus, a feature defining with “first” and “second” may explicitly or implicitly include at least one of the features. In addition, “and/or” appearing throughout the text means that three parallel solutions are included, for example, “A and/or B” includes A solution, B solution, or solution that satisfies A and B simultaneously. In addition, the technical solutions among the various embodiments may be combined with each other, but must be based on the fact that the technical solutions can be realized by those of ordinary skill in the art, and when the combination of the technical solutions contradicts or cannot be realized, it should be considered that the combination of the technical solutions does not exist or fall within the protection scope claimed by the present disclosure.

### <Hardware Configuration>

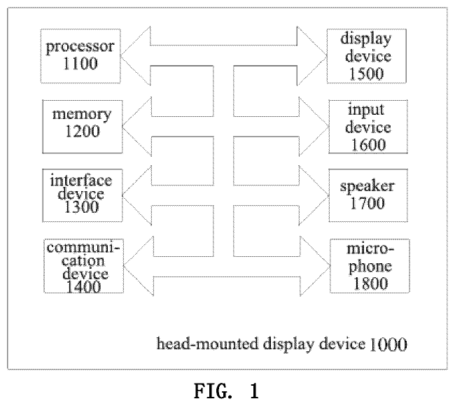

FIG. 1 is a block diagram of hardware configuration of a head-mounted display device 1000 according to an embodiment of the present disclosure.

As illustrated in FIG. 1, the head-mounted display device 1000 may be smart glasses such as AR glasses or other devices, but the disclosure is not limited thereto.

In an embodiment, as illustrated in FIG. 1, the head-mounted display device 1000 may include a processor 1100, a memory 1200, an interface device 1300, a communication device 1400, a display device 1500, an input device 1600, a speaker 1700, a microphone 1800, and the like.

The processor 1100 may include but is not limited to a central processing unit (CPU), a microprocessor (MCU), etc. The memory 1200 includes, for example, a read-only memory (ROM), a random-access memory (RAM), a non-volatile memory such as a hard disk, etc. The interface device 1300 includes, for example, various bus interfaces, such as a serial bus interface (including a USB interface), a parallel bus interface, etc. The communication device 1400 is capable of wired or wireless communication, for example. The display device 1500 is, for example, a liquid crystal display screen, an LED display screen, an Organic Light-Emitting-Diode (OLED) display screen, or the like. The input device 1600 includes, for example, a touch screen, a keyboard, a joystick, etc. The head-mounted display device 1000 may output audio information through the speaker 1700, and may collect audio information through the microphone 1800.

It should be understood by those skilled in the art that although a plurality of devices of the head-mounted display device 1000 are shown in FIG. 1, the head-mounted display device 1000 of the embodiments of the present disclosure may only relate to some of the devices, and may also include other devices, but the disclosure is not limited thereto.

In this embodiment, the memory 1200 of the head-mounted display device 1000 is configured to store instructions for controlling the processor 1100 to perform operations to implement or support implementation of the control method according to any embodiment. Those skilled in the art may design instructions according to the solutions disclosed in the present specification. How the instructions control the operation of the processor is well known in the art and will not be described in detail herein.

In the above description, those skilled in the art may design instructions according to the solutions provided by the present disclosure. How the instructions control the operation of the processor is well known in the art and will not be described in detail herein.

The head-mounted display device shown in FIG. 1 is merely illustrative and is in no way intended to limit the invention, its application, or uses.

Various embodiments and examples according to the present disclosure are described below with reference to the accompanying drawings.

### <Method Embodiment>

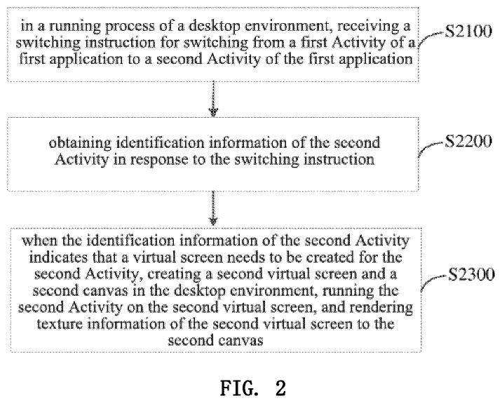

FIG. 2 shows a control method according to an embodiment of the present disclosure, which may be implemented by a head-mounted display device, or may be implemented by a control apparatus independent of the head-mounted display device and the head-mounted display device, or may be implemented by a cloud server and the head-mounted display device, and the head-mounted display device may be AR glasses.

As illustrated in FIG. 2, the control method of this embodiment may include the following steps S2100 to S2300:

Step S2100: in a running process of a desktop environment, receiving a switching instruction for switching from a first Activity of a first application to a second Activity of the first application.

A first virtual screen and a first canvas are created in the desktop environment, the first virtual screen runs the first Activity, and the first canvas renders texture information of the first virtual screen.

The first application is an application in the head-mounted display device and may be an Android application, and the first Activity and the second Activity are different Activities in the first application, and different functions in the first application are executed by different Activities.

In this embodiment, a desktop launcher of the head-mounted display device is referred to as an AR Launcher, the AR Launcher is automatically started when the head-mounted display device is powered on, the desktop environment of the head-mounted display device starts to run, and after a user wears the head-mounted display device, the head-mounted display device displays the desktop environment within the range of the user's line of sight. It may be understood that the desktop environment is generally a 3D desktop environment.

In an optional embodiment, the first Activity is an initial Activity, and before the receiving the first switching instruction for switching from the first Activity of the first application to the second Activity of the first application, the control method in this embodiment of the present disclosure may further include: in the running process of the desktop environment, receiving a start instruction for starting the first application; and in response to the start instruction, creating the first virtual screen and the first canvas in the desktop environment, running the first Activity on the first virtual screen, and rendering texture information of the first virtual screen to the first canvas.

The first virtual screen is a virtual screen created by the head-mounted display device for the first application, and the first virtual screen may generally run a plurality of Activities. It can be understood that the head-mounted display device may run, on the first virtual screen, all Activities in the first application that do not need a new virtual screen to be created.

As an example, an icon of application 1 is displayed in the desktop environment of the head-mounted display device, and the user taps the icon of the application 1, so that the head-mounted display device may create virtual screen 1 and canvas 1 in the desktop environment, run Activity1 of the application 1 (an initial Activity of the application 1) on the virtual screen 1, and render texture information of the virtual screen 1 to the canvas 1. In this case, the user may implement, in Activity1, a switching instruction for switching to Activity2 of Application 1.

After the step S2100 of receiving the switching instruction for switching from the first Activity of the first application to the second Activity of the first application in the running process of the desktop environment, where a first virtual screen and a first canvas are created in the desktop environment, the first virtual screen runs the first Activity, and the first canvas renders texture information of the first virtual screen, the method proceeds to:

Step S2200: obtaining identification information of the second Activity in response to the switching instruction.

The identification information of the second Activity is used to identify whether a virtual screen needs to be created for the second Activity. Specifically, when the identification information of the second Activity is “1”, it indicates that a virtual screen needs to be created for the second Activity, and when the identification information of the second Activity is “0”, it indicates that a virtual screen does not need to be created for the second Activity, that is, the head-mounted display device continues to run the second Activity on the first virtual screen.

In this embodiment, the step S2200 of obtaining the identification information of the second Activity in response to the switching instruction may further include the following steps S2210 to S2220:

Step S2210: obtaining a first mapping table and class name information of the second Activity in response to the switching instruction.

The first mapping table reflects a correspondence between class name information of an Activity of the first application and identification information of the Activity, and the identification information is used to indicate whether a virtual screen needs to be created for the Activity.

It should be noted that the first mapping table may be a first hash table, the key (Key) of the first hash table is the class name information of the Activity of the first application, and the hash value (Value) corresponding to the key is the identification information of the Activity. Generally, the hash value is a Boolean value, for example, the identification information of the Activity may be “1”, indicating that a virtual screen needs to be created for the Activity, and for another example, the identification information of the Activity may be “0”, indicating that a virtual screen does not need to be created for the Activity.

Generally, the head-mounted display device may automatically create the first mapping table for the first application when the first application is started, and of course, the head-mounted display device may also synchronously acquire the first mapping table corresponding to the first application provided by the provider of the first application in a case where the first application is installed. Certainly, the user may further modify the first mapping table, for example, the user may manually modify identification information of an Activity of the first application from “1” to “0”.

As an example, the application 1 includes an Activity1, an Activity2, and an Activity3, the Activity1 is an initial Activity of the application 1, and the first mapping table may be as shown in Table 1:

TABLE 1
The first mapping table corresponding to the application 1

| Key | Value |
|---|---|
| Class Name Information of Activity1 | 0 |
| Class Name Information of Activity2 | 1 |
| Class Name Information of Activity3 | 0 |

It can be learned from Table 1 that, when the Key is the class name information of Activity1, the corresponding Value is “0”, indicating that the head-mounted display device does not separately create a corresponding virtual screen for the Activity1; but when the application 1 is started, creates a virtual screen 1 for the application 1, and runs the Activity1 on the virtual screen 1. When the Key is the class name information of Activity3, the corresponding Value is “0”, indicating that the head-mounted display device does not separately create a corresponding virtual screen for Activity3, but runs Activity3 on the virtual screen 1. When the Key is the class name information of Activity2, the corresponding Value is “1”, indicating that the head-mounted display device will separately create a corresponding virtual screen for Activity2. It can be understood that the first virtual screen is used to run all Activities whose values are “0” in the first mapping table.

Step S2220: obtaining the identification information of the second Activity according to the first mapping table and the class name information of the second Activity.

Continuing with the above example, the head-mounted display device obtains Table 1, and determines from Table 1 that the Key is the class name information of Activity2 and the corresponding Value is “1”.

After the step S2200 of obtaining the identification information of the second Activity in response to the switching instruction, the method proceeds to:

Step S2300: when the identification information of the second Activity indicates that a virtual screen needs to be created for the second Activity, creating a second virtual screen and a second canvas in the desktop environment, running the second Activity on the second virtual screen, and rendering texture information of the second virtual screen to the second canvas.

Continuing with the above example, the Key is the class name information of Activity2 and the corresponding Value is “1”, indicating that a new virtual screen needs to be created for Activity2, the head-mounted display device may create a virtual screen 2 and a canvas 2, run the Activity2 of the application 1 on the virtual screen 2, and render texture information of the virtual screen 2 to the canvas 2.

In an optional embodiment, the head-mounted display device further obtains package name information of the first application, attribute information of the first virtual screen, attribute information of the second virtual screen, class name information of the first Activity, and class name information of the second Activity; and updates a second mapping table and a third mapping table based on the package name information of the first application, the attribute information of the first virtual screen, the attribute information of the second virtual screen, the class name information of the first Activity, and the class name information of the second Activity.

The attribute information of the virtual screen may be an ID of the virtual screen.

The second mapping table reflects a correspondence between package name information of any application and attribute information of a virtual screen running the any application.

The third mapping table reflects a correspondence between attribute information of any virtual screen and class name information of an Activity running on the any virtual screen.

It should be noted that the second mapping table may be a second hash table, a key (Key) of the second hash table is package name information of any application, and a hash value (Value) corresponding to the key is attribute information of a virtual screen corresponding to the any application. Generally, the second hash table has a one-to-many relationship. The third mapping table may be a third hash table, a key (Key) of the third hash table is attribute information of any virtual screen, and a hash value (Value) corresponding to the key is class name information of an Activity corresponding to the any virtual screen. Generally, the third hash table has a one-to-many relationship.

According to the embodiment of the present disclosure, a first virtual screen and a first canvas are created in the desktop environment, the first virtual screen runs a first Activity of a first application, the first canvas renders texture information of the first virtual screen. When a switching instruction for switching from the first Activity to a second Activity of the first application is received, identification information of the second Activity may be obtained in response to the switching instruction, and in a case in which the identification information of the second Activity indicates that a virtual screen needs to be created for the second Activity, a second virtual screen and a second canvas are created in the desktop environment, the second Activity runs on the second virtual screen, and texture information of the second virtual screen is rendered to the second canvas, so that different Activities of the first application can be simultaneously presented to a user, thereby implementing an effect of switching different Activities of a same application, and the user does not need to repeatedly switch between different Activities.

In an embodiment, the control method of the embodiment of the present disclosure further includes the following steps S3100 to S3300:

Step S3100: creating a third virtual screen, a third canvas, a fourth virtual screen, and a fourth canvas in the desktop environment, wherein the third virtual screen runs a third Activity of a second application, the third canvas renders texture information of the third virtual screen, and the fourth virtual screen runs a fourth Activity of the second application.

As an example, virtual screen 3, canvas 3, virtual screen 4, and canvas 4 are further created in the desktop environment of the head-mounted display device, where the virtual screen 3 runs Activity1 of application 2, the canvas 3 renders texture information of the virtual screen 3, the virtual screen 4 runs Activity2 of the application 2, and the canvas 4 renders texture information of the virtual screen 4.

Step S3200: displaying the first canvas and the second canvas in a stacked manner, and displaying the first canvas or the second canvas at a top layer as a first main canvas corresponding to the first application.

The first main canvas corresponding to the first application is a canvas corresponding to an Activity when the user last operates the Activity of the first application. Continuing with the above example, the main canvas corresponding to the application 1 may be the canvas 1 corresponding to the Activity1, or may be the canvas 2 corresponding to the Activity2. When the main canvas corresponding to the application 1 is the canvas 1 corresponding to the Activity1, the canvas 1 and the canvas 2 are displayed in a stacked manner, and the canvas 1 is displayed at a top layer. When the main canvas corresponding to the application 1 is the canvas 2 corresponding to the Activity2, the canvas 1 and the canvas 2 are displayed in a stacked manner, and the canvas 2 is displayed at the top layer.

Step S3300: displaying the third canvas and the fourth canvas in a stacked manner, and displaying the third canvas or the fourth canvas at a top layer as a second main canvas corresponding to the second application.

The second main canvas corresponding to the second application is a canvas corresponding to an Activity when the user last operates the Activity of the second application. Continuing with the above example, the main canvas corresponding to the application 2 may be the canvas 3 corresponding to the Activity1, or the canvas 4 corresponding to the Activity2. When the main canvas corresponding to the application 2 is the canvas 3 corresponding to the Activity1, the canvas 3 and the canvas 4 are displayed in a stacked manner, and the canvas 3 is displayed at a top layer. When the main canvas corresponding to the application 2 is the canvas 4 corresponding to the Activity2, the canvas 3 and the canvas 4 are displayed in a stacked manner, and the canvas 4 is displayed at the top layer.

According to the present embodiment, in a scenario where the desktop environment of the head-mounted display device implements running multiple applications, each application only displays a canvas corresponding to the Activity when the user last operates the Activity of the application.

In an embodiment, the control method of the embodiment of the present disclosure further includes: obtaining package name information of the second application, attribute information of the third virtual screen, attribute information of the fourth virtual screen, class name information of the third Activity, and class name information of the fourth Activity; and updating the second mapping table and the third mapping table based on the package name information of the second application, the attribute information of the third virtual screen, the attribute information of the fourth virtual screen, the class name information of the third Activity, and the class name information of the fourth Activity.

In an embodiment, the control method of the embodiment of the present disclosure further includes: receiving a first touch input for a target main canvas; and in response to the first touch input, expanding and displaying other canvases stacked with the target main canvas.

The target main canvas is the first main canvas or the second main canvas.

Continuing with the above example, when the main canvas corresponding to the application 1 is the canvas 1 corresponding to the Activity1, the canvas 1 and the canvas 2 are displayed in a stacked manner, and the canvas 1 is displayed at the top layer. When the user performs touch input for the canvas 1, the head-mounted display device may expand and display the canvas 1 and the canvas 2 in the desktop environment.

When the main canvas corresponding to the application 1 is the canvas 2 corresponding to the Activity2, the canvas 1 and the canvas 2 are displayed in a stacked manner, and the canvas 2 is displayed at the top layer. When the user performs touch input for the canvas 2, the head-mounted display device may expand and display the canvas 1 and the canvas 2 in the desktop environment.

Continuing with the above example, when the main canvas corresponding to the application 2 is the canvas 3 corresponding to the Activity1, the canvas 3 and the canvas 4 are displayed in a stacked manner, and the canvas 3 is displayed at the top layer. When the user performs touch input for the canvas 3, the head-mounted display device may expand and display the canvas 3 and the canvas 4 in the desktop environment.

When the main canvas corresponding to the application 2 is the canvas 4 corresponding to the Activity2, the canvas 3 and the canvas 4 are displayed in a stacked manner, and the canvas 4 is displayed at the top layer. When the user performs touch input for the canvas 4, the head-mounted display device may expand and display the canvas 3 and the canvas 4 in the desktop environment.

According to this embodiment, when the user selects and operates a certain application, a canvas corresponding to the application may be expanded and displayed in the desktop environment.

In an embodiment, the control method of the embodiment of the present disclosure further includes the following steps S4100 to S4300:

Step S4100: obtaining class name information of a target Activity when a second touch input for the target Activity is received.

Step S4200: querying the third mapping table according to the class name information of the target Activity to obtain attribute information of a target virtual screen corresponding to the class name information of the target Activity.

Step S4300: distributing, according to the attribute information of the target virtual screen, the second touch input to the target Activity running on the target virtual screen for response.

According to this embodiment, the head-mounted display device transmits the second touch input to the target Activity running on the target virtual screen according to the third mapping table for response.

In an embodiment, the control method of the embodiment of the present disclosure further includes the following steps S5100 to 5300:

Step S5100: obtaining package name information of a target application in response to a first close instruction for closing the target application.

The target application may be the first application or the second application.

Step S5200: querying the second mapping table according to the package name information of the target application to obtain attribute information of a target virtual screen corresponding to the package name information of the target application.

Step S5300: querying the third mapping table according to the attribute information of the target virtual screen to obtain attribute information of a target Activity corresponding to the attribute information of the target virtual screen.

Step S5400: releasing the corresponding target Activity according to the attribute information of the target Activity.

According to this embodiment, the user may select to close the entire application, and the head-mounted display device queries the second mapping table for attribute information of the virtual screen corresponding to the application, then queries the second mapping table for class name information of the Activity corresponding to the virtual screen, and then releases the resource of the corresponding Activity.

In an embodiment, the control method of the embodiment of the present disclosure further includes the following steps S6100 to 6300:

Step S6100: obtaining class name information of the target Activity in response to a second close instruction for closing the target Activity.

The target Activity may be the first Activity, the second Activity, the third Activity, or the fourth Activity.

Step S6200: querying the third mapping table according to the class name information of the target Activity to obtain attribute information of a target virtual screen corresponding to the class name information of the target Activity.

Step S6300: releasing the target Activity running on the target virtual screen according to the attribute information of the target virtual screen and the class name information of the target Activity.

According to this embodiment, the user may select to close a certain Activity separately, and the head-mounted display device queries the third mapping table for attribute information of the virtual screen corresponding to the Activity, and then releases the resource of the Activity running on the virtual screen.

### <Apparatus Embodiment>

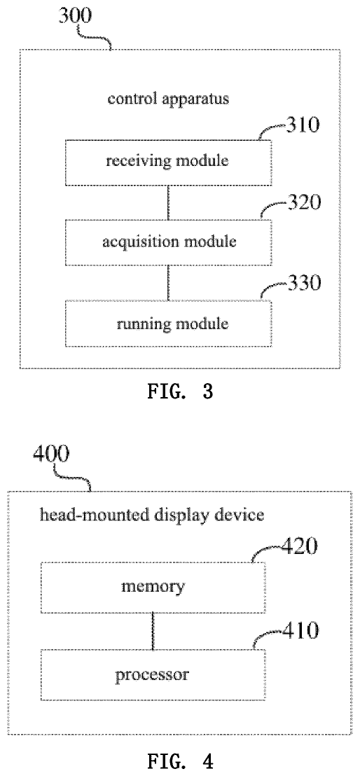

FIG. 3 is a functional block diagram of a control apparatus according to an embodiment of the present disclosure. Referring to FIG. 3, a control apparatus 300 includes a receiving module 310, an acquisition module 320, and a running module 330.

The receiving module 310 is configured to receive a switching instruction for switching from a first Activity of a first application to a second Activity of the first application in a running process of a desktop environment, wherein a first virtual screen and a first canvas are created in the desktop environment, the first virtual screen runs the first Activity, and the first canvas renders texture information of the first virtual screen.

The acquisition module 320 is configured to obtain identification information of the second Activity in response to the switching instruction.

The running module 330 is configured to create a second virtual screen and a second canvas in the desktop environment when the identification information of the second Activity indicates that a virtual screen needs to be created for the second Activity, run the second Activity on the second virtual screen, and render texture information of the second virtual screen to the second canvas.

In an embodiment, the acquisition module 320 is specifically configured to: obtain a first mapping table and class name information of the second Activity in response to the switching instruction, wherein the first mapping table reflects a correspondence between class name information of an Activity of the first application and identification information of the Activity, and the identification information is used to indicate whether a virtual screen needs to be created for the Activity; and obtain the identification information of the second Activity according to the first mapping table and the class name information of the second Activity.

In an embodiment, the receiving module 310 is further configured to receive a start instruction for starting the first application in the running process of the desktop environment.

The running module 330 is further configured to, in response to the start instruction, create the first virtual screen and the first canvas in the desktop environment, run the first Activity on the first virtual screen, and render the texture information of the first virtual screen to the first canvas.

In an embodiment, a third virtual screen, a third canvas, a fourth virtual screen, and a fourth canvas are further created in the desktop environment, the third virtual screen runs a third Activity of the second application, the third canvas renders texture information of the third virtual screen, and the fourth virtual screen runs a fourth Activity of the second application. The apparatus 300 further includes a display module (not shown).

The display module is configured to: display the first canvas and the second canvas in a stacked manner, and display the first canvas or the second canvas at a top layer as a first main canvas corresponding to the first application; and display the third canvas and the fourth canvas in a stacked manner, and display the third canvas or the fourth canvas at a top layer as a second main canvas corresponding to the second application.

In an embodiment, the receiving module 310 is further configured to receive a first touch input for a target main canvas, where the target main canvas is the first main canvas or the second main canvas;

the display module is further configured to expand and display other canvases stacked with the target main canvas in response to the first touch input.

In an embodiment, the apparatus 300 further includes an updating module (not shown).

The acquisition module 320 is further configured to obtain package name information of the first application, attribute information of the first virtual screen, attribute information of the second virtual screen, class name information of the first Activity, and class name information of the second Activity;
the updating module is configured to update a second mapping table and a third mapping table based on the package name information of the first application, the attribute information of the first virtual screen, the attribute information of the second virtual screen, the class name information of the first Activity, and the class name information of the second Activity; and
the acquisition module 320 is further configured to obtain package name information of the second application, attribute information of the third virtual screen, attribute information of the fourth virtual screen, class name information of the third Activity, and class name information of the fourth Activity;
the updating module is further configured to update the second mapping table and the third mapping table based on the package name information of the second application, the attribute information of the third virtual screen, the attribute information of the fourth virtual screen, the class name information of the third Activity, and the class name information of the fourth Activity;
wherein the second mapping table reflects a correspondence between package name information of any application and attribute information of a virtual screen running the any application; and
the third mapping table reflects a correspondence between attribute information of any virtual screen and class name information of an Activity running on the any virtual screen.

In an embodiment, the apparatus 300 further includes a sending module (not shown).

The acquisition module 320 is further configured to: obtain class name information of a target Activity when a second touch input for the target Activity is received; and query the third mapping table according to the class name information of the target Activity to obtain attribute information of a target virtual screen corresponding to the class name information of the target Activity;

the sending module is configured to distribute, according to the attribute information of the target virtual screen, the second touch input to the target Activity running on the target virtual screen for response.

In an embodiment, the acquisition module 320 is further configured to: obtain package name information of a target application in response to a first close instruction for closing the target application; and query the second mapping table according to the package name information of the target application to obtain attribute information of a target virtual screen corresponding to the package name information of the target application; and

the running module 330 is further configured to release the corresponding target Activity according to the attribute information of the target Activity.

In an embodiment, the acquisition module 320 is further configured to: obtain class name information of the target Activity in response to a second close instruction for closing the target Activity; and query the third mapping table according to the class name information of the target Activity to obtain attribute information of a target virtual screen corresponding to the class name information of the target Activity;

the running module 330 is further configured to release the target Activity running on the target virtual screen according to the attribute information of the target virtual screen and the class name information of the target Activity.

According to the embodiment of the present disclosure, a first virtual screen and a first canvas are created in the desktop environment, the first virtual screen runs a first Activity of a first application, and the first canvas renders texture information of the first virtual screen. When a switching instruction for switching from the first Activity to a second Activity of the first application is received, identification information of the second Activity may be obtained in response to the switching instruction, and in a case in which the identification information of the second Activity indicates that a virtual screen needs to be created for the second Activity, a second virtual screen and a second canvas are created in the desktop environment, the second Activity runs on the second virtual screen, and texture information of the second virtual screen is rendered to the second canvas, so that different Activities of the first application can be simultaneously presented to a user, thereby implementing an effect of switching different Activities of a same application, and the user does not need to repeatedly switch between different Activities.

### <Device Embodiment>

FIG. 4 is a schematic diagram of a hardware structure of a head-mounted display device according to an embodiment. As shown in FIG. 4, a head-mounted display device 400 includes a processor 410 and a memory 420.

The memory 420 may be configured to store executable computer instructions.

The processor 410 may be configured to perform the control method according to the method embodiments of the present disclosure under the control of the executable computer instructions.

The head-mounted display device 400 may be the head-mounted display device 1000 shown in FIG. 1, or may be a device with other hardware structures, which is not limited herein.

In another embodiment, the head-mounted display device 400 may include the above control apparatus 300.

In an embodiment, the modules of the control apparatus 300 may be implemented by the processor 410 by running computer instructions stored in the memory 420.

### <Computer-Readable Storage Medium>

An embodiment of the present disclosure further provides a computer-readable storage medium having computer instructions stored thereon, and when the computer instructions are executed by a processor, the control method provided by the embodiments of the present disclosure is executed.

The present disclosure may be a system, a method, and/or a computer program product. The computer program product may include a computer-readable storage medium (or media) having computer-readable program instructions thereon for causing a processor to implement aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium, or to an external computer or external storage device via a network, for example, the Internet, a local area network, a wide area network and/or a wireless network. The network may include copper transmission cables, optical fiber transmission, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for performing operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In scenarios involving the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to implement aspects of the present disclosure.

Aspects of the present disclosure are described herein with reference to flowchart illustrations and/or block diagrams of the method, apparatus (system), and computer program product according to embodiments of the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of general-purpose computers, special-purpose computers, or other programmable data processing apparatus to produce a machine, such that the instructions, which execute via the processor of the computer or other programmable data processing apparatus, create means for implementing the functions/acts specified in one or more blocks of the flowchart illustrations and/or block diagrams. These computer-readable program instructions may also be stored in a computer-readable storage medium so that a computer, a programmable data processing apparatus, and/or other devices can function in a particular manner, thereby, the computer-readable storage medium having instructions stored therein includes an article of manufacture including instructions which implement aspects of the function/act specified in one or more blocks of the flowchart illustrations and/or block diagrams.

The computer-readable program instructions may also be loaded onto a computer, other programmable data processing apparatus, or other devices to cause a series of operational steps to be performed on the computer, other programmable data processing apparatus, or other devices to produce a computer implemented process, such that the instructions executed on the computer, other programmable data processing apparatus, or other devices implement the function/act specified in one or more blocks of the flowchart illustrations and/or block diagrams.

The flowchart illustrations and block diagrams in the drawings illustrate the architecture, functionality, and operation of possible implementations of the system, method, and computer program product according to various embodiments of the present disclosure. In this regard, each block in the flowchart illustrations or block diagrams may represent a module, segment, or portion of instructions, which includes one or more executable instructions for implementing the specified logical function(s). In some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or can be implemented by combinations of special-purpose hardware and computer instructions. It is well known to those skilled in the art that implementation by hardware, implementation by software, and implementation by a combination of software and hardware are all equivalent.

It should be noted that terms such as “include”, “comprise” or any other variation thereof are intended to encompass a non-exclusive inclusion such that a process, method, article or system that includes a series of elements includes not only those elements, but also other elements not explicitly listed, or elements inherent to such a process, method, article or system. Without further limitation, the element defined by the phrase “including a . . . ” does not preclude the presence of additional identical elements in the process, method, article or system including the element.

The sequence numbers of the embodiments of the present disclosure are merely for description, and do not represent the preference of the embodiments.

Through the description of the foregoing implementations, a person skilled in the art may clearly understand that the method in the foregoing embodiments may be implemented by using software and a necessary general hardware platform, or may be implemented by using hardware, but in many cases, the former may be better. Based on such understanding, the technical solution of the present disclosure essentially or the part contributing to the prior art may be embodied in the form of a software product, and the computer software product is stored in a storage medium (such as a ROM/RAM, a magnetic disk, or an optical disk) as above, and includes several instructions to enable a terminal device (which may be a mobile phone, a computer, a server, a television, or a network device, etc.) to execute the method of each embodiment of the present disclosure.

The above descriptions are only preferred embodiments of the present disclosure, and are not intended to limit the patent scope of the present disclosure, and any equivalent structural transformation made by using the content of the specification and the accompanying drawings of the present disclosure or direct/indirect applications in other related technical fields under the inventive concept of the present disclosure are included in the patent protection scope of the present disclosure.

1. A control method, comprising:
receiving a switching instruction for switching from a first Activity of a first application to a second Activity of the first application in a running process of a desktop environment, wherein a first virtual screen and a first canvas are created in the desktop environment, the first virtual screen runs the first Activity, and the first canvas renders texture information of the first virtual screen;
obtaining identification information of the second Activity in response to the switching instruction; and
when the identification information of the second Activity indicates that a virtual screen needs to be created for the second Activity, creating a second virtual screen and a second canvas in the desktop environment, running the second Activity on the second virtual screen, and rendering texture information of the second virtual screen to the second canvas.

2. The control method of claim 1, wherein the obtaining the identification information of the second Activity in response to the switching instruction comprises:
obtaining a first mapping table and class name information of the second Activity in response to the switching instruction, wherein the first mapping table reflects a correspondence between class name information of an Activity of the first application and identification information of the Activity, and the identification information of the Activity is configured to indicate whether a virtual screen needs to be created for the Activity; and
obtaining the identification information of the second Activity according to the first mapping table and the class name information of the second Activity.

3. The control method of claim 1, wherein the first Activity is an initial Activity, and wherein before the receiving the switching instruction for switching from the first Activity of the first application to the second Activity of the first application, the control method further comprises:
receiving a start instruction for starting the first application in the running process of the desktop environment; and
in response to the start instruction, creating the first virtual screen and the first canvas in the desktop environment, running the first Activity on the first virtual screen, and rendering the texture information of the first virtual screen to the first canvas.

4. The control method of claim 1, further comprising:
creating a third virtual screen, a third canvas, a fourth virtual screen, and a fourth canvas in the desktop environment, wherein the third virtual screen runs a third Activity of a second application, the third canvas renders texture information of the third virtual screen, and the fourth virtual screen runs a fourth Activity of the second application;
displaying the first canvas and the second canvas in a stacked manner, and displaying the first canvas or the second canvas at a top layer as a first main canvas corresponding to the first application; and
displaying the third canvas and the fourth canvas in a stacked manner, and displaying the third canvas or the fourth canvas at a top layer as a second main canvas corresponding to the second application.

5. The control method of claim 4, further comprising:
receiving a first touch input for a target main canvas, wherein the target main canvas is the first main canvas or the second main canvas; and
expanding and displaying other canvases stacked with the target main canvas in response to the first touch input.

6. The control method of claim 4, further comprising:
obtaining package name information of the first application, attribute information of the first virtual screen, attribute information of the second virtual screen, class name information of the first Activity, and class name information of the second Activity;
updating a second mapping table and a third mapping table based on the package name information of the first application, the attribute information of the first virtual screen, the attribute information of the second virtual screen, the class name information of the first Activity, and the class name information of the second Activity;
obtaining package name information of the second application, attribute information of the third virtual screen, attribute information of the fourth virtual screen, class name information of the third Activity, and class name information of the fourth Activity; and
updating the second mapping table and the third mapping table based on the package name information of the second application, the attribute information of the third virtual screen, the attribute information of the fourth virtual screen, the class name information of the third Activity, and the class name information of the fourth Activity;
wherein the second mapping table reflects a correspondence between package name information of any application and attribute information of a virtual screen running the any application; and
the third mapping table reflects a correspondence between attribute information of any virtual screen and class name information of an Activity running on the any virtual screen.

7. The control method of claim 6, further comprising:
obtaining class name information of a target Activity when a second touch input for the target Activity is received;
querying the third mapping table according to the class name information of the target Activity to obtain attribute information of a target virtual screen corresponding to the class name information of the target Activity; and
distributing, according to the attribute information of the target virtual screen, the second touch input to the target Activity running on the target virtual screen for response.

8. The control method of claim 6, further comprising:
obtaining package name information of a target application in response to a first close instruction for closing the target application;
querying the second mapping table according to the package name information of the target application to obtain attribute information of a target virtual screen corresponding to the package name information of the target application;
querying the third mapping table according to the attribute information of the target virtual screen to obtain attribute information of a target Activity corresponding to the attribute information of the target virtual screen; and
releasing the corresponding target Activity according to the attribute information of the target Activity.

9. The control method of claim 6, further comprising:
obtaining class name information of a target Activity in response to a second close instruction for closing the target Activity;
querying the third mapping table according to the class name information of the target Activity to obtain attribute information of a target virtual screen corresponding to the class name information of the target Activity; and
releasing the target Activity running on the target virtual screen according to the attribute information of the target virtual screen and the class name information of the target Activity.

10. A control apparatus, comprising:
a receiving module configured for receiving a switching instruction for switching from a first Activity of a first application to a second Activity of the first application in a running process of a desktop environment, wherein a first virtual screen and a first canvas are created in the desktop environment, the first virtual screen runs the first Activity, and the first canvas renders texture information of the first virtual screen;
an acquisition module configured for obtaining identification information of the second Activity in response to the switching instruction; and
a running module configured for creating a second virtual screen and a second canvas in the desktop environment when the identification information of the second Activity indicates that a virtual screen needs to be created for the second Activity, running the second Activity on the second virtual screen, and rendering texture information of the second virtual screen to the second canvas.

11. A head-mounted display device, comprising:
a memory configured to store executable computer instructions; and
a processor configured to perform, under control of the executable computer instructions, the control method according to claim 1.

12. A computer-readable storage medium, on which computer instructions are stored, wherein the computer instructions, when executed by a processor, implements the control method according to claim 1.
